(19) United States
(12) Patent Application Publication
(10) Pub. No.: US 2024/0180090 A1
(43) Pub. Date: Jun. 6, 2024

(54) DEEP ROOT IRRIGATION DEVICE AND RELATED METHODS

(71) Applicant: Gabriel Lopez, Farmersville, CA (US)

(72) Inventor: Gabriel Lopez, Farmersville, CA (US)

(21) Appl. No.: 18/506,936

(22) Filed: Nov. 10, 2023

Related U.S. Application Data
(60) Provisional application No. 63/424,138, filed on Nov. 10, 2022.
(60) Provisional application No. 63/438,931, filed on Jan. 13, 2023.
(60) Provisional application No. 63/471,829, filed on Jun. 8, 2023.
(60) Provisional application No. 63/531,558, filed on Aug. 9, 2023.

(51) Int. Cl. A01G 25/06

(52) U.S. Cl. CPC A01G 25/06

(57) ABSTRACT

The present invention provides a subsurface drip irrigation tube that is operable to hydrate plant roots and is configurable to attach to various drip irrigation connectors. The irrigation tube may be incorporated into an irrigation system and includes an internal filtration material that prevents rodents and pest from chewing through the tubing and weighs down tube to prevent uproot of the tube. The irrigation tube eliminates the need for above surface anchors, and other fastening methods.

The present application claims priority to pending U.S. Provisional Patent Application Nos. 63/424,138 (filed Jan. 17, 2023), 63/438,931 (filed Feb. 7, 2023), 63/471,829 (filed Jun. 16, 2023), and 63/531,558 (filed Aug. 15, 2023), which are incorporated herein by this reference.

### FIELD OF THE INVENTION

The present invention relates to a device that is operable to deliver irrigation water in a subterranean manner and related methods. More particularly, the invention relates to a device that is inserted into the ground in the region of a plants roots and provides for deep root watering of a plant and related methods. The device can be integrated into conventional drip irrigation systems.

### SUMMARY OF THE INVENTION

The present invention provides a device and method for providing irrigation water to a plant's roots in a manner that avoids wasting water and that promotes the growth of the roots by direct subterranean delivery. The device may include a tube, connector, and tubular emitter device that is operable to disperse water efficiently into the soil surrounding the roots of the plant without ingress of significant amounts of soil into the emitter. Prior emitter designs suffer from clogging due to the presence of soil adjacent to the emitter. The invention connects to an existing irrigation drip system and thus can be implemented without having to redesign an irrigation system.

The emitter may be a rigid or semi-rigid tube having a length in a range of about 4 inches to about 18 inches and having a diameter in a range of about .25 inch to about 1.5 inches. The emitter may have perforations along substantially its entire length that have a diameter in a range of about a 1/16 inch to about ¼ inch. The perforations may also be arranged around the circumference of the emitter, e.g., in multiple columns (e.g., 2, 3, 4, or more columns spaced apart evenly around the circumference) along the length of the emitter, which provides an emitter that delivers water to a maximized three-dimensional space. The emitter may be filled with a filtration material to both allow the water delivered to the device from the drip irrigation system to be distributed in an even and measured manner, and to provide a barrier to the ingress of soil into the emitter. The filtration material may be coarse material that has sufficient size so as not to be blown out of the perforations as irrigation water or air passes through the emitter, but also sufficiently fine to be packed to prevent ingress of the soil. In some embodiments, the filter material may comprise a gravel material having an average diameter greater than the perforations. In some embodiments, the filter material includes a crushed and packable rock material, such as crushed granite, that packs together well and is resistant to being dislodged by the irrigation water. In some embodiments, the filter material may include combinations of different materials, such as a combination of one or more of a gravel material, a crushed rock, sand, or other material (e.g., to fill gaps between the pieces of gravel).

Such materials will also provide sufficient mass to prevent the emitter from being ejected from the ground when air passes through the drip irrigation system to which the emitter is connected. Such air is pumped through the drip irrigation system when water is run through the system after a period of non-use. The water dissipates from the drip irrigation system during periods of non-use. Reinitiating use of the drip irrigation results in the irrigation water pumping air through the system. Without the mass of the filter material of the present invention, the emitter may be ejected from the soil due to the air pressure.

The irrigation device may be buried next to a plant in the region of the roots to provide water directly to the roots while avoiding the excess use of irrigation water. Irrigation device when buried may extend downward in a substantially vertical manner such that the emitter extends into the area roots. Preferably, the coupling is comprised of copper. The irrigation device may be placed underground by digging a hole, placing the irrigation device in the hole, and backfilling the hole with an aerating composition, such as gravel and/or sand. The hole is preferably substantially vertical.

It is an aspect of the present invention to provide a subterranean water delivery system that includes a plurality of emitter tubes positioned below the surface, each tube having a sealed distal end and an open proximal end, the proximal end may be operable to receive a connector; a plurality of perforations concentrically distributed between the proximal and distal end of the tube; an irrigation system in communication with a water pump that may be operable to couple to each of the connectors and provide fluid to said tube; the plurality of emitter tubes may be spaced evenly along a row crop and positioned in the ground adjacent to the roots of a plant and when the irrigation system is engaged, the perforations are operable to uniformly distribute water to the soil. The emitter tubes may be filled with a filtration material that is water permeable and operable to reinforce the structure of the emitter tube.

It is another aspect of the present invention to provide a subterranean water delivery system that includes a plurality of emitter tubes positioned below the surface, each tube having an open distal end and an open proximal end, the proximal end may be operable to receive a connector; a plurality of perforations concentrically distributed between the proximal and distal end of the tube; an irrigation system in communication with a water pump that may be operable to couple to each of the connectors and provide fluid to said tube; the plurality of emitter tubes may be spaced evenly along a row crop and positioned in the ground adjacent to the roots of a plant and when the irrigation system is engaged, the perforations are operable to uniformly distribute water to the soil. The emitter tubes may be filled with a filtration material that is water permeable and operable to reinforce the structure of the emitter tube.

It is still another aspect of the present invention to provide a subterranean water delivery system that includes an emitter tube that is partially positioned below the surface, each tube having a distal end and an open proximal end, the proximal end may be operable to receive a connector; and a plurality of perforations concentrically distributed near the distal end of the tube and positioned below the ground. In some embodiments, the distal end of the emitter tube may be open to allow flow of water therethrough. In some embodiments, the subterranean water delivery system may include a removable reinforcing rod for insertion into said open proximal end to maintain the proximal end of the irrigation tube in a substantially vertical orientation. In some embodiments, the subterranean water delivery system may include a plurality of emitter tubes spaced evenly along a row crop and positioned in the ground adjacent to the roots of a plant and when the irrigation system is engaged. In some embodiments, the subterranean water delivery system may include irrigation system in communication with a water pump that may be operable to couple to each of the connectors and provide fluid to said tube. The emitter tubes may be filled with a filtration material that is water permeable and operable to reinforce the structure of the emitter tube.

Further aspects and embodiments will be apparent to those having skill in the art from the description and disclosure provided herein.

It is an object of the present invention to provide a drip irrigation subterranean emitter tube that is operable to hydrate the roots of a plant and has a longer life than existing subsurface drip irrigation systems, and to provide a filtration material in the tube that is operable to increase weight and prevent uprooting and to prevent rodents from chewing on the tubing.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of a tubular emitter with perforations, according to an embodiment of the present invention.

FIG. 2 provides a perspective view of a tubular emitter with perforations, according to an embodiment of the present invention.

FIG. 3 provides a front view of a tubular emitter that contains filtration material and a cross sectional view inside the tube, according to an embodiment of the present invention.

FIG. 4 provides a front view of a tubular emitter with perforations, according to an embodiment of the present invention.

FIG. 5 provides an environmental view of the irrigation system with several tubular emitters, a pump, crop, soil, and tee-connected piping connectors, according to an embodiment of the present invention.

FIG. 6 provides a front view of a tubular emitter with perforations, according to an embodiment of the present invention.

FIG. 7 provides an environmental view of the irrigation system with several tubular emitters, a pump, crop, soil, and tee-connected piping connectors, according to an embodiment of the present invention.

### DETAILED DESCRIPTION

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

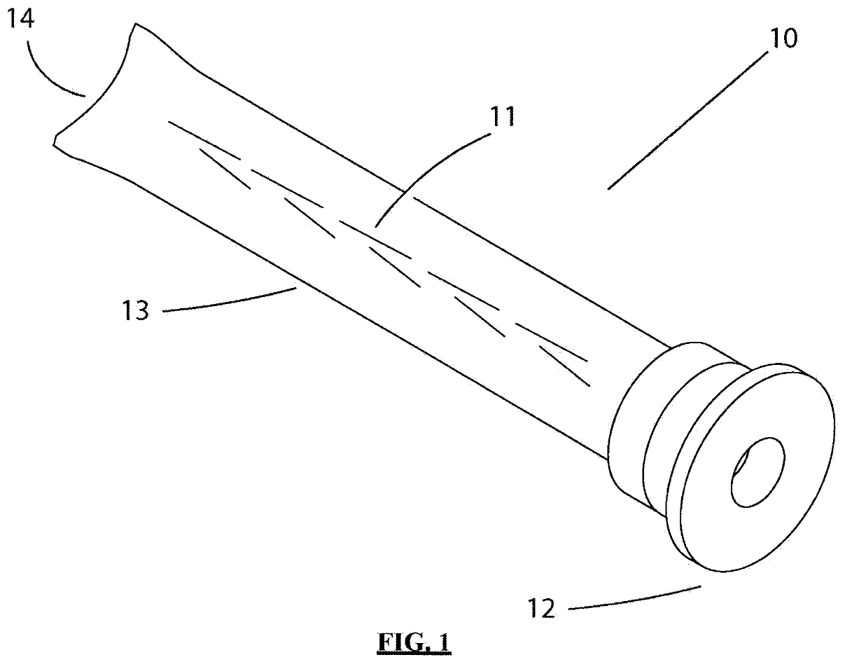

Reference will be made to the exemplary illustrations in the accompanying drawings, and reference characters may be used to designate like or corresponding parts throughout the several views of the drawings. FIGS. 1-7 provide views of an exemplary embodiment of a novel tubular emitter having a tubing and connector design.

The irrigation device of the present design provides water to a plant's roots by connecting to a pre-existing irrigation drip system. The tubular emitter 10 may contain a cap 12 to attach to the irrigation drip system 50, The tubular emitter may include a series of perforations 11 that are operable to disperse a filtration material, tubing 13 to secure filtration material alongside water and nipple 14. The cap 12 may have a nipple 14 that is operable to connect an irrigation device to a water source using a drip line.

In some embodiments, the irrigation device as shown in the perspective view of FIG. 1 may include a tubular emitter 10 with cap 12, tubing 13, perforations 11, and nipple 14. In other embodiments, the perforations 11 may have various constant geometries that wrap around the circumference of the tubing. In other embodiments, the tubular cap 12 may be shaped like an outward nose (not shown) to connect to a pre-existing irrigation drip system 50. This may enable the user to attach their own tubing and drippers for multi-purpose drip irrigation systems.

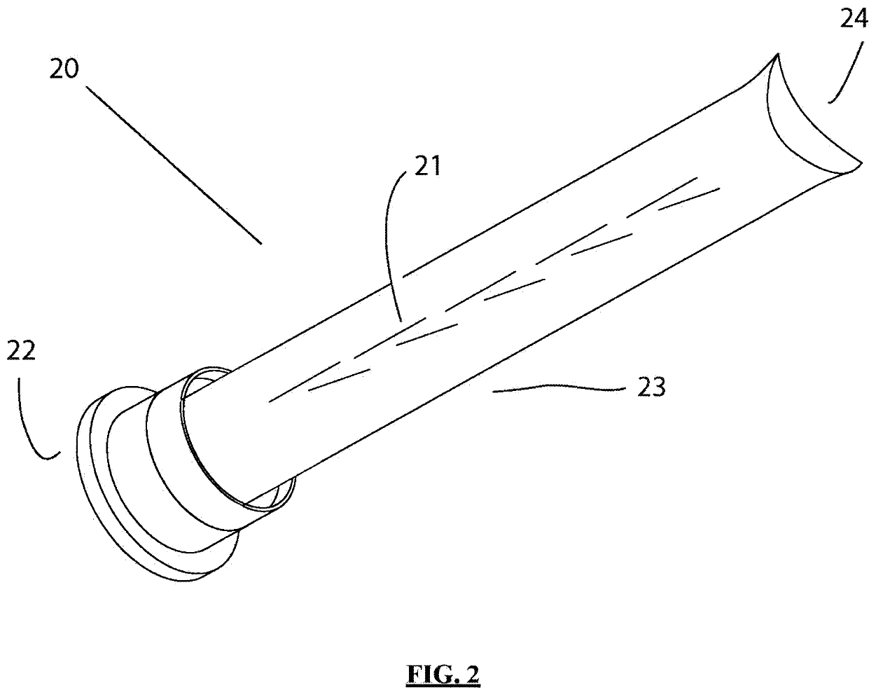

In some embodiments, as shown in another perspective view, FIG. 2 shows a tubular emitter 20 with cap 22, tubing 23, perforations 21, and nipple 24. In other embodiments, the perforations 21 may have various constant geometries that wrap around the circumference of the tubing. Each perforation's shape may be consistent throughout the circumference of the tubular emitter 20 to allow water passage through roots. In other embodiments, the tubular cap 22 may be shaped like an outward nose (not shown) to connect to a pre-existing irrigation drip system 50. This may enable the user to attach their own tubing and drippers for multi-purpose drip irrigation systems.

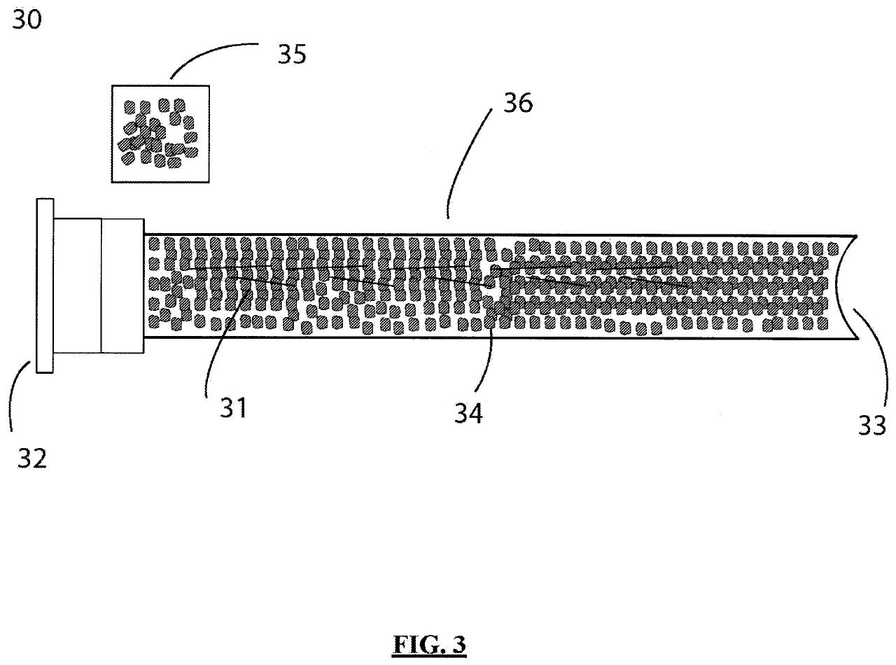

FIG. 3 shows a front view of a tubular emitter 30 with perforations 31, cap 32, nipple 33, filtration material 34, and emitter tubing 36. A cross-sectional view 35 shows the placement of filtration material inside connector 32. The filtration material 34 may use a packable crushed rock material that has a diameter larger than that of the perforations 31. In other embodiments, the filtration material 34 may include one or more of gravel, crushed rock sand, or other crushed material that is larger than the perforation diameter. In other embodiments, connector 31 may have an outward cap with nose end (not shown) to attach to a pre-existing drip irrigation system 50. In some embodiments, the irrigation drip system 50 may use polyethylene tubing for the tubing connector 32. Polyethylene tubing may provide a longer life span, UV protection, resistance to cracking, and flexible design, and is widely used for drip irrigation applications. Other materials for tubing may include polyvinyl chloride (PVC), galvanized iron, and other materials that can adapt to rapid changes in pressure from water flow.

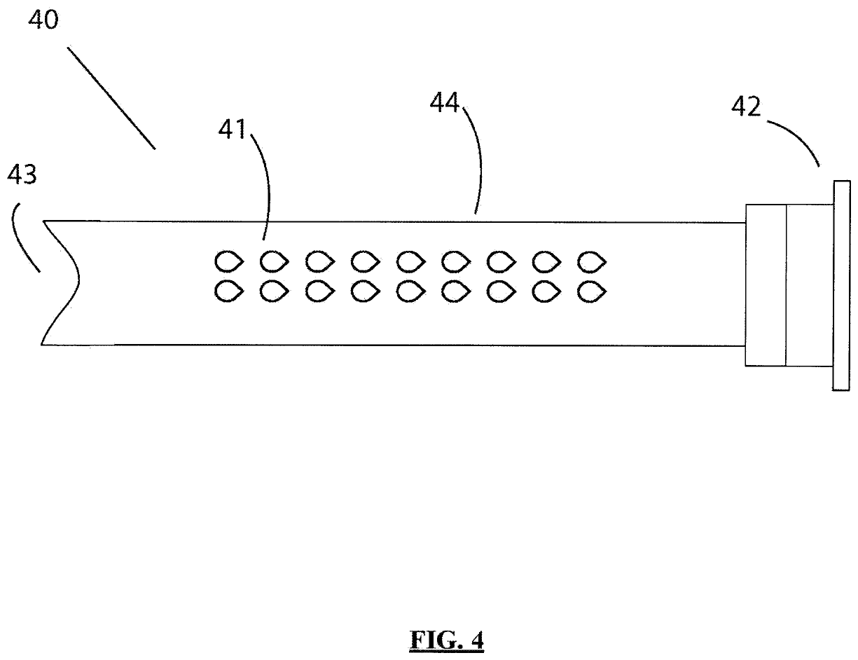

FIG. 4 shows a tubular emitter 40 with perforations 41, cap 42, nipple 43, and emitter tubing 44. In the same embodiment, perforations 41 may be substantially conical, and cap 42 includes an orifice to attach to a drip irrigation system 50. In other embodiments, the shape of the perforations 41 may be rectangular, circular, or any shape that is positioned around the circumference of the tubing 40 and may have a maximum diameter of ¼ inch and a minimum diameter of about 1/16 inch and a cap 42 may be shaped outward with a nose (not shown). The shape of the perforations 41 may be consistent around the circumference of the tubing to allow uniform water flow through plant roots. In other embodiments, there may be filtration material 34 added inside the emitter tubing 44 to avoid excess system water pressure and provide balanced water flow. The filtration material 34 may consist of one or more of gravel, crushed rock, sand, or any packable crushed material.

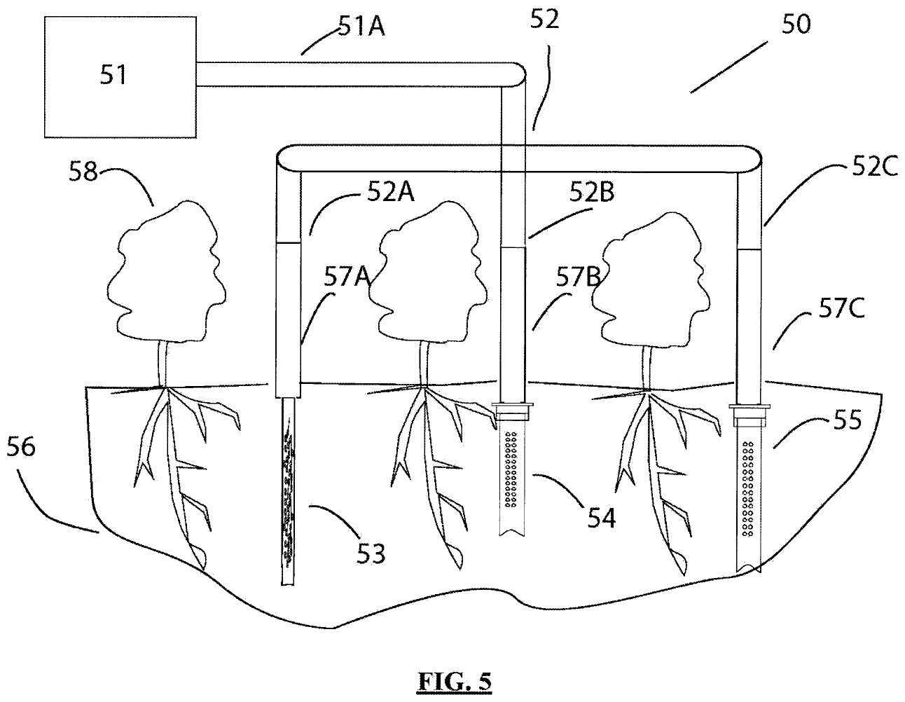

FIG. 5 shows an environmental view of an exemplary irrigation system 50. The irrigation system 50 may include a pump 51, a plurality of connectors 52, tubular emitter 10, having a tubular “capped” connector 52A, tubular emitter 20, tubular emitter 40, tubular emitters 53-55 of various constant geometries, tubular connectors 57A-C, ground view 56, and tree 58. Connector 52 can be connected to the full assembly using tee-fitting, elbow fittings, cross-fitting, or any type of fitting that can change the direction of water flow to the connectors. A mainline 51A is connected to a water pump 51, where mainline 51A has various lines 51A-C that T off the mainline using a tee-connector 52. These various lines 52A-C may then couple to various tubular emitters using tubing connectors 57A-C that may be receiving various tubular emitters 53-55. In other embodiments, there may be more than three tubular emitters in a linear array that are complementary/received from a plurality of connectors 57 A-C which may T off the main line using a tee-fitting 52 and a plurality of capped connectors 52A-C. In other embodiments, tree 58 may be a different crop that can receive water from an irrigation drip system 50. Examples of such crops can include corn, wheat, soybeans, and other vegetables that require irrigation. In other embodiments, tubular emitters 53-55 may contain different filtration materials 34 such as gravel, sand, or other crushable material. In other embodiments, tubular emitters 53-55 may have different perforation shapes in the form of rectangles, circles, or other shapes. In such embodiments, the perforations 11 may be shaped around the circumference of the tubing in multiple columns (2,3,4 . . . ) along the length of the tubing and may have a maximum diameter of about ½ inch, a minimum diameter of about 1/64 inch, and any diameter therebetween. In other embodiments, each tubular emitter 10 may have a different cap geometry to accommodate a variety of tubing from pre-existing drip irrigation systems 50. Perforations within each tubular emitter 10 may have consistent shapes to allow water flow through plant roots. In some embodiments, the cap connector 52A may include be shaped with an orifice in the middle, an outward nose, or any fitted cap that can attach to an appropriately sized tubing design for a drip irrigation system 50.

In some embodiments, water may flow from an underground short length of connector 51A through an above ground water line operated using pump 51. In such embodiments, the water flow may be regulated by a line-integrated water-flow-regulating in-line dripper. Water may also flow from pipe 51 using a tee-connection 52 that diverts the flow of water in varying directions. In some embodiments, there may be a plurality of tee-connections 52 that divert the water flow in a plurality of directions using capped connectors 52A-C. The tee-connection 52 may branch off to various capped connectors 52A with a midpoint opening to allow tubing/dripper inserts. These inserts may include a variety of different tubing shapes and sizes depending on the amount of water flow that is required. In some embodiments, the capped connector 52A may include small holes around the length of the pipe to allow water to flow underground. This will also allow the piping to be inspected dry to investigate if water is flowing or not. The holes may be large enough for a person skilled in the art to be able to manually inspect, unlike traditional drippers with miniscule holes naked to the human eye. In the same embodiment, there may be sand or gravel filled inside emitter 53 to prevent a drastic increase in water system air pressure, which may force the tubular emitter 53 off the ground, rendering it useless. The filtration material 34 may also allow the water to flow evenly within the tubular emitter. This added weight may increase the longevity of the tubular emitter 53, provide better irrigation to crops that may be farmed, and prevent rodents from chewing on the piping. Examples of some crops may include trees, common vegetables, and any farming crop that requires large scale irrigation. In traditional irrigation drippers, the insides of the tubular emitters 53 are hollow such that rodents like gophers or squirrels can chew through them, rendering them ineffective. In other embodiments, a plurality of tubular emitters 53-55 may be received by a plurality of tubing connectors 57A-C which may be coupled to a plurality of capped connectors 52A-C which may be laid out in a tee-fitting system 52. The present invention may be filled with filtration material to prevent this occurrence.

In some embodiments, there may be three tubular emitters 53-55 connected evenly in a linear pattern to a tee-connected piping system 52 attached with three capped connectors 52A-C to a water line pump system 51. Each capped connector 52A-C may be placed complementary or on the receiving end of various tubular emitters 53-55 that evenly disperse water to the crop 58 soil using perforations 11. In such embodiments, there may be sand or gravel inside each of the tubular emitters 53-55 to prevent excess water system air pressure from pushing the tubular emitters 53-55 off the ground. In other embodiments, there may be a plurality of filtration materials 34 inside a plurality of tubular emitters 53-55 including, charcoal filtration, packable crushed rocks, mineral treatment additives, and other mediums that can filter water. In some embodiments, each tubular emitter 53-55 may have a different perforation shape 11 to disperse more water to a specific root. In some embodiments, there may be a plurality of capped connectors 52A-52C with a plurality of tubing connectors 57A-57C that may receive a plurality of tubular emitters 53-55 to disperse soil to a plurality of crops 58.

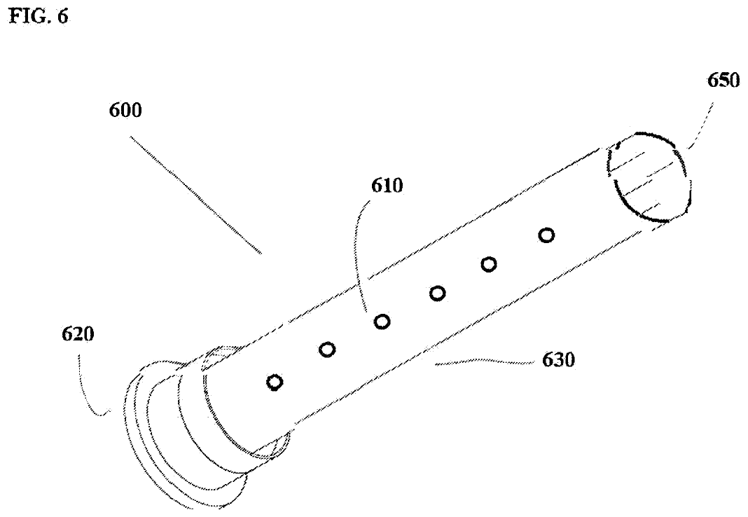

FIG. 6 shows a tubular emitter 600 with perforations 610, cap 620, emitter tubing 630, and an open distal end 650. In the same embodiment, perforations 610 may be substantially triangular, and cap 620 includes an orifice to attach to a drip irrigation system 60. In other embodiments, the shape of the perforations 610 may be rectangular, circular, or any shape that is positioned around the circumference of the tubing 630 and may have a maximum diameter of ¼ inch and a minimum diameter of about 1/16 inch and a cap 620 may be shaped outward with a nose (not shown). The shape of the perforations 610 may be consistent around the circumference of the tubing to allow uniform water flow through plant roots. In some embodiments, there may be filtration material 34 added inside the emitter tubing 630 to avoid excess system water pressure and provide balanced water flow. The filtration material 34 may consist of one or more of gravel, crushed rock, sand, or any packable crushed material. In other embodiments, the emitter tubing may be inserted into the ground without any filtration material placed in the tubing 630.

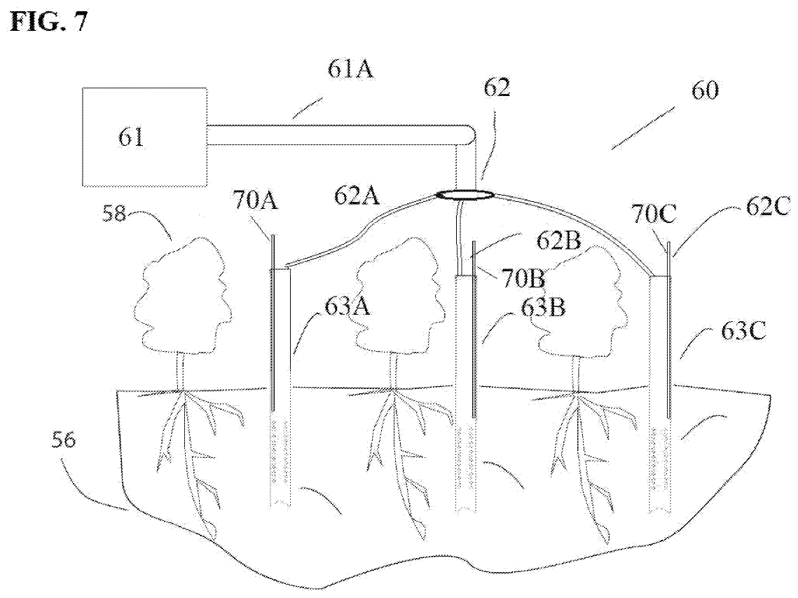

FIG. 7 shows an environmental view of an exemplary irrigation system 60. The irrigation system 60 may include a pump 61, a connector manifold 62, plurality of lines 62A, 62B, and 62C, tubular emitters 63A, 63B, and 63C, having perforations 64A, 64B, and 64C of various constant geometries, ground view 56, and tree 58. Lines 62 can be connected to the full assembly using tee-fitting, clip, barb, elbow fittings, cross-fitting, or any type of fitting operable to connect the connectors to the emitters 63A-63C. The tubular emitters 63A-C may each have an above ground, proximal section and a below ground distal section. This arrangement prevents clogging of the emitter and allows for easy maintenance and connection of water delivery lines. For example, about 40% to about 60% of the tubular emitter may be positioned above the soil. This arrangement may result in the proximal portion of the tubular emitter being exposed to harvesting or trimming machinery, which may strike the proximal portion. To reinforce the vertical orientation of the proximal section of the tubular emitter, reinforcing rods 70A, 70B, and 70C may be included in the proximal section of the tubular emitters to prop up the tubular emitters and resist the collapse of the tubular emitters when struck by machinery. The reinforcing rods may be fabricated from polymer materials (e.g., polyvinyl chloride, nylon, polyethylene, and other appropriate polymer materials), metal (e.g., aluminum, aluminum alloys, stainless steel, and other appropriate metal materials), and other appropriate rigid materials.

In some embodiments, a mainline 61A is connected to a water pump 61, where mainline 61A has various lines 62A-C that T off the mainline. In other embodiments, there may be more than three tubular emitters in a linear array that are complementary/received from a plurality of lines 62A-C. In other embodiments, tree 58 may be a different crop that can receive water from an irrigation drip system 50. Examples of such crops can include corn, wheat, soybeans, and other vegetables that require irrigation. In other embodiments, tubular emitters may contain different filtration materials such as gravel, sand, or other crushable material. In other embodiments, tubular emitters may have different perforation shapes in the form of rectangles, circles, or other shapes. In such embodiments, the perforations 11 may be shaped around the circumference of the tubing in multiple columns (2,3,4 . . . ) along the length of the tubing and may have a maximum diameter of about ½ inch, a minimum diameter of about 1/64 inch, and any diameter therebetween. Perforations within each tubular emitter may have consistent shapes to allow water flow through plant roots.

In some embodiments, water may flow from an underground short length of connector 51A through an above ground water line operated using pump 51. In such embodiments, the water flow may be regulated by a line-integrated water-flow-regulating in-line dripper. These inserts may include a variety of different tubing shapes and sizes depending on the amount of water flow that is required.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A subterranean water delivery device, comprising:
a. a tube having a first end and a second end, wherein said first end is operable to receive a connector and said second end is sealed;
b. a tubular emitter positioned between said first end and second end of the tube that is operable to disperse water into the soil;
c. a water permeable filtration material filling said tube that is operable to provide a tangential reinforcement to said tube; and
d. an irrigation system in communication with a water pump that is operable to route fluid to said connector of said tube;
wherein said tube is positioned in the ground adjacent to the roots of a plant and said connector is above surface and operable to connect to said irrigation system.

2. The device of claim 1, wherein said tubular emitter includes a plurality of perforations positioned concentrically along the length of said tube and are operable to evenly distribute fluid to the roots of a plant.

3. The device of claim 2, wherein said perforations have a consistent aperture to allow water passage through to plant roots.

4. The device of claim 3, wherein said consistent aperture has a substantially conical geometry.

5. The device of claim 1, wherein said connector is a female or male receiver for a barbed connector that is operable to couple the tube to said irrigation system.

6. The device of claim 1, wherein said filtration material is a packageable crushed material.

7. The device of claim 1, further comprising a plurality of irrigation tubes forming a row of irrigation tubes and being coupled to said irrigation system.

8. A subterranean water delivery device, comprising:
a. a tube having a first end and a second end, wherein said first end is operable to receive a connector and said second end is open;
b. a tubular emitter positioned between said first end and second end of the tube that is operable to disperse water into the soil; and
c. a connector at a proximal end of said tube operable to connect with an irrigation system having a water pump that is operable to route fluid to said connector of said tube;
wherein said tube is positioned in the ground adjacent to the roots of a plant and said connector is above surface and operable to connect to said irrigation system.

9. The device of claim 8, wherein said tubular emitter includes a plurality of perforations positioned concentrically along the length of said tube and are operable to evenly distribute fluid to the roots of a plant.

10. The device of claim 9, wherein said perforations have a consistent aperture to allow water passage through to plant roots.

11. The device of claim 10, wherein said consistent aperture has a substantially triangular geometry.

12. The device of claim 8, wherein said connector is a female or male receiver for a barbed connector that is operable to couple the tube to said irrigation system.

13. The device of claim 8, further comprising a filtration material in said tubular emitter that is a packageable crushed material.

14. A subterranean water delivery system, comprising:
a. a plurality of emitter tubes positioned below the surface, each tube having a sealed distal end and an open proximal end, wherein said proximal end is operable to receive a connector;
b. a plurality of perforations concentrically distributed between said proximal and distal end of said tube; and
c. an irrigation system in communication with a water pump that is operable to couple to each of said connectors and provides fluid to said tube;
wherein said plurality of emitter tubes are spaced evenly along a row crop and positioned in the ground adjacent to the roots of a plant and when said irrigation system is engaged, the perforations are operable to uniformly distribute water to the soil.

15. The system of claim 14, wherein said tubular emitter includes a plurality of perforations positioned concentrically along the length of said tube and are operable to evenly distribute fluid to the roots of a plant.

16. The system of claim 15, wherein said perforations have a consistent aperture to allow water passage through to plant roots.

17. The system of claim 16, wherein said consistent aperture has a substantially triangular geometry.

18. The system of claim 14, wherein said connector is a female or male receiver for a barbed connector that is operable to couple the tube to said irrigation system.

19. The system of claim 14, further comprising a filtration material in said tubular emitter that is a packageable crushed material.
